(19) United States
(12) Patent Application Publication
(10) Pub. No.: US 2006/0155866 A1
(43) Pub. Date: Jul. 13, 2006

(54) Method of data gathering of user network

(75) Inventor: Xiaoshan Wei, Shenzhen (CN)

Correspondence Address: SEED INTELLECTUAL PROPERTY LAW GROUP PLLC, 701 FIFTH AVE, SUITE 6300, SEATTLE, WA, 98104-7092, US

(73) Assignee: Huawei Technologies Co. Ltd., Shenzhen (CN)

(21) Appl. No.: 10/533,276

(22) PCT Filed: Aug. 13, 2003
(86) PCT No.: PCT/CN03/00670

§ 371 Date: Feb. 14, 2006

(30) Foreign Application Priority Data
Oct. 31, 2002 (CN) 02148313.2

(51) Int. Cl. G06F 15/16

(52) U.S. Cl. 709/231

(57) ABSTRACT

A method for collecting network usage data of a user in which access device in the network authenticates and authorizes the user, and an AAA server records the user's network resources information authenticated and authorized. IN addition, during network access a router records network usage information and sends the network usage information with UDP messages to an NSC, the NSC aggregates the collected network usage information, the association analysis server performs real-time association analysis for the aggregated network usage data and user network resource information uploaded from AAA server to obtain detailed network usage data of the user. The network usage data collected with the method according to the present invention is comprehensive and compact; the final network usage data can be oriented to users directly; and thus the method can meet the data demand of diverse applications, such as content accounting, destination IP accounting, real-time accounting, network monitoring, and user behavior analysis, etc.

### BACKGROUND OF THE INVENTION

1. Field of the Invention

The present invention relates to a method for collecting network usage data for a user, which belongs to the technical field of computer networks.

2. Description of the Related Art

As the Internet evolves increasingly, users of the Intranet, Internet Service Providers (hereinafter referred to as ISP) and broadband networks grow rapidly, the categories of network service are becoming profuse, and network usage is gradually diversified. In such a case, operators and managers of network services demand to master user's usage of network resources in detail so as to implement more flexible accounting, plan reasonably, and manage and monitor network resources effectively.

Obtaining user network usage data in an efficient, accurate, and real-time manner can be difficult. Presently, a typical solution is to configure a monitoring server, which collects the data related with the address, port, and traffic in Internet Protocol (hereinafter referred to as IP) messages forwarded via routers and, on that basis, perform statistical review and analysis to obtain network usage data of users. The flow is shown in FIG. 1.

Though detailed network usage data can be obtained by using a monitoring server, that method has the following disadvantages:

1. The method requires an additional high-performance server; since the data volume to be collected is vast, thus support of mass storage devices is required, which increases networking cost.

2. The method can collect only network resource occupation data such as IP address and port number, but is unable to determine the users who occupy the network resources. To support applications such as content accounting, further process is required.

3. The method is poor in real-time feature and thus cannot meet the demand of real-time applications such as real-time accounting and real-time monitoring.

### BRIEF SUMMARY OF THE INVENTION

The disclosed embodiments of the present invention provide a method for collecting network usage data of a user, which uses association between NetStream technology and Remote Authentication Dial-In User Service (hereinafter referred to as Radius) Protocol to achieve efficient and real-time collection of network usage data of the user and provide essential data for network usage-based management and accounting.

The method for collecting network usage data of a user according to the present invention includes the following steps:

(1) An access device authenticating and authorizing the user, and an Authentication, Authorization and Accounting Server (hereinafter referred to as AAA server) recording the user's network resource information that is authenticated and authorized;

(2) a router, during network access, recording network usage information, and sending the network usage information to a NetStream Collector (hereinafter referred to as NSC) with User Datagram Protocol (hereinafter referred to as UDP) messages;

(3) the NSC aggregating the collected network usage information; and

(4) the association analysis server performing real-time association analysis for the aggregated network usage information and the user's network resource information uploaded from the AAA server to obtain detailed network usage data of the user.

The access device in the method is any one of LAN switch, access server, or IP phone gateway.

Step (1) in which an access device authenticates and authorizes the user and an AAA server records the user's network resource information includes the following steps:

(1) The access device sending the user's authentication and authorization data to the AAA server;

(2) the AAA server analyzing and recording the user's authentication and authorization data, and sending the control information of network access permission to the access device;

(3) the access device allocating resources to the user and sending the user's network resource information to the AAA server, which records the user's network resource information; and

(4) the AAA server forwarding the user's network resource information to the association analysis server in real time.

Wherein, the resources allocated by the access device to the user include: IP address, and start time and stop time of network access, as well as bandwidth (optional). The user's network resource information recorded by AAA server includes: user's account number, start time and stop time of network access, IP address, network access location, and service attribute.

In step (2) of the method, the network usage information recorded by the router includes: source IP address, destination IP address, source port number, destination port number, number of bytes, and timestamp.

The association analysis in step (4) of the method is: matching the IP address and start time and stop time of network access in the user's network resource information to the IP address and timestamp in the network usage information, to determine the user corresponding to the network usage information.

The advantage of the method for collecting network usage data of a user according to the present invention is: it will not affect network usage for the user; in addition, due to the advanced design of NetStream, the method will not degrade IP message forwarding rate; instead, it may speed up the forwarding rate in certain cases. Through aggregation, association, and analysis, the method associates isolated network usage information with the user's network resource information uploaded from the AAA server organically, so that it can collect the user's network resource usage information in real time and record accurately user access to websites (IP addresses), services (port numbers), and duration and traffic in a certain time period. Furthermore, the network usage information collected with this method is comprehensive, and the data is compact through aggregation; thus the method will not occupy vast storage resources. The final network usage data created with this method may be oriented to users directly, to meet the data demand of diverse applications, such as content accounting, destination IP accounting, real-time accounting, network monitoring, and user behavior analysis. In addition, the method is advantageous in real-time and can meet the real-time demand of the majority of applications.

### BRIEF DESCRIPTION OF THE DRAWINGS

FIG. 1 is a networking diagram of the commonly used method for collecting network usage data presently; and

FIG. 2 is the networking diagram of the method for collecting network usage data of a user according to the present invention.

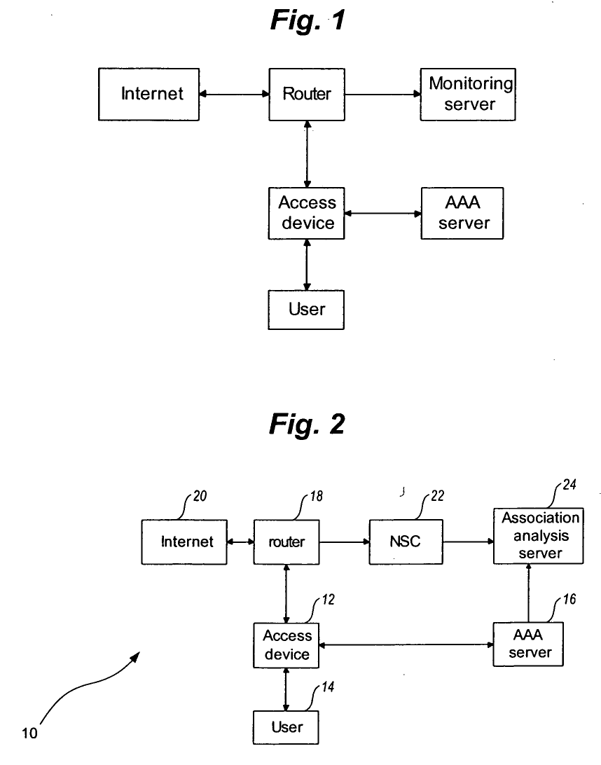

### DETAILED DESCRIPTION OF THE INVENTION

The present invention employs the networking solution 10 as shown in FIG. 2. Firstly, an access device 12 authenticates and authorizes a user 14, and an AAA server 16 records the user's network resource information authenticated and authorized. Next, during network access, a router 18 records network usage information, such as from the Internet 20, and sends the network usage information to an NSC 22 with UDP messages. The NSC 22 aggregates the collected network usage information, and an association analysis server 24 performs real-time association analysis for the aggregated network usage information and the user's network resource information uploaded from the AAA server 16 to obtain detailed network usage data of the user 14.

The access device 12 in the method may be any one of LAN switch, access server, or IP phone gateway.

In the method, the process in which the access device 12 authenticates and authorizes the user 14 and the AAA server 16 records the user's network resource information is as follows: Firstly, the access device 12 sends the user's authentication and authorization data to the AAA server 16. Next the AAA server 16 analyzes and records the user's authentication and authorization data and sends the network access control information to the access device 12; the access 12 device allocates resources to the user 14 and sends the user's network resource information to the AAA server 16, which records the user's network resource information. The AAA server 16 forwards the user's network resource information to the association analysis server 24 in real time. Wherein, the resources allocated by the access device 12 to the user include: IP address, and start time and stop time of network access, as well as bandwidth (optional). The user's network resource information recorded by the AAA server 16 includes: a user's account number, start time and stop time of network access, IP address, network access location, and service attribute.

In the method, the network usage information recorded by the router 18 includes: source IP address, destination IP address, source port number, destination port number, number of bytes, and timestamp.

The association analysis in the method includes matching the IP address and the start time and stop time of network access in the user's network resource information to the IP address and the timestamp in the network usage information, to determine the user corresponding to the network usage information.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method for collecting network usage data of a user, comprising the following steps:
(1) an access device authenticating and authorizing the user, and an Authentication, Authorization and Accounting Server (hereinafter referred to as AAA server) recording the user's network resource information authenticated and authorized;
(2) a router, during network access, recording network usage information, and sending the network usage information to a NetStream Collector (NSC) with User Datagram Protocol messages;
(3) the NSC aggregating the collected network usage information; and
(4) the association analysis server performing real-time association analysis for the aggregated network usage information and the user's network resource information uploaded from the AAA server to obtain detailed network usage data of the user.

2. The method according to claim 1, wherein the access device in step (1) is one of a LAN switch, an access server, and an IP phone gateway.

3. The method according to claim 1, wherein step (1) in which the access device authenticates and authorizes the user and the AAA server records the user's network resource information comprises the following steps:
(1) the access device sending the user's authentication and authorization data to the AAA server;
(2) the AAA server analyzing and recording the user's authentication and authorization data, and sending control information of the network access permission to the access device;
(3) the access device allocating resources to the user and sending the user's network resource information to the AAA server, which records the user's network resource information; and
(4) the AAA server forwarding the user's network resource information to the association analysis server in real time.

4. The method according to claim 3, wherein in step (3), the resources allocated by the access device to the user comprise an IP address, and a start time and a stop time of network access.

5. The method according to claim 3, wherein in step (3), the resources allocated by the access device to the user comprise an IP address, a start time and a stop time of network access, and bandwidth.

6. The method according to claim 3, wherein in step (3), the user's network resource information recorded by the AAA server comprises a user's account number, a start time and a stop time of network access, an IP address, a network access location, and a service attribute.

7. The method according to claim 1, wherein in step (2), the network usage information recorded by the router comprises a source IP address, a destination IP address, a source port number, a destination port number, a number of bytes, and a timestamp.

8. The method according to claim 1, wherein the association analysis in step (4) comprises matching the IP address and a start time and a stop time of network access in the user's network resource information to the IP address and the timestamp in the network usage information to determine the user corresponding to the network usage information.
